(19) United States
(12) Patent Application Publication
(10) Pub. No.: US 2025/0270085 A1
(43) Pub. Date: Aug. 28, 2025

(54) SLURRY TANK

(71) Applicant: Albert Posthumus, Stephenville, TX (US)

(72) Inventor: Albert Posthumus, Stephenville, TX (US)

(21) Appl. No.: 19/059,010

(22) Filed: Feb. 20, 2025

Related U.S. Application Data
(60) Provisional application No. 63/556,961, filed on Feb. 23, 2024.

(51) Int. Cl. B67D 7/00; B60P 3/22; B60P 3/30; B67D 7/02

(52) U.S. Cl. CPC B67D 7/002; B60P 3/2245; B60P 3/225; B60P 3/30; B67D 7/02

(57) ABSTRACT

Provided herein is a slurry tank having an articulated boom providing a fluid pathway from an end of the boom to the slurry tank, the boom being articulated such that it is selectably positionable in a first and a second position. When the boom is in the first position, the end of the boom is located outside of the slurry tank and, when the boom is in the second position, the end of the boom is located inside of the slurry tank.

### PRIORITY CLAIM

This application claims the benefit under 35 U.S.C. 119 (e) of U.S. Provisional Patent Application No. 63/556,961, entitled “Slurry Tank,” filed Feb. 23, 2024, naming Albert Posthumous as inventor, the entire disclosure of which is incorporated herein by reference in its entirety.

### TECHNICAL FIELD

The present disclosure relates to slurry tanks, and in particular, to a system and method for efficiently transporting and unloading a slurry material, such as fertilizer, from a slurry tank.

### BACKGROUND

Slurry tanks are containment vessels designed to hold slurry materials, i.e., liquids having suspended or saturated solids. Slurries may be transported in slurry tanks to various worksites or other locations where they are needed. For example, a slurry fertilizer may include solid or liquid manure suspended in a liquid medium, such as water. The slurry fertilizer may be transported to crop fields for distribution through use of a slurry tank.

Challenges arise with slurry tanks, as the slurries carried within are kept in motion. If a slurry material is allowed to still, solids suspended in the liquid will separate or settle out of the liquid medium, resulting in large chunks of solids in the liquid that may damage slurry tank parts or that may clog the piping associated with the slurry tank. Further, settling may lead to the formation of deposits of solid material in the slurry tank that is difficult to remove. Recirculating the slurry material to prevent settling may require the use of several pumps or other recirculation structures. There is a need for new and economical slurry tank systems and methods of using the same.

### SUMMARY OF THE INVENTION

In a first aspect, provided herein is a slurry tank system including: a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and a boom in fluid communication with the first inlet of the slurry tank and providing a fluid passageway from a first end of the boom to the tank volume through the first inlet of the slurry tank, wherein at least a portion of the compartment volume is at a lower elevation than the tank volume, and the boom is articulated to allow the first end of the boom to move in at least three degrees of freedom.

In some embodiments, the slurry tank system includes a pump positioned at the first end of the boom, the boom providing a fluid passageway between the pump and the tank volume. In some embodiments, the slurry tank system includes a first flow valve positioned between the boom and the slurry tank, the first flow valve providing fluid communication between the boom and the slurry tank when the first flow valve is in an open position. In some embodiments, the slurry tank system includes a spray nozzle in fluid communication with the tank volume via an outlet of the slurry tank; the spray nozzle configured to discharge a slurry material stored in the slurry tank when a spray valve is in an open position.

In some embodiments, the slurry tank system includes a recirculation line, the recirculation line providing a fluid passageway between the boom and the second inlet of the slurry tank such that a slurry material stored within the slurry tank can be recirculated through the recirculation line to prevent the slurry material from separating. In some embodiments, the slurry tank system includes a second flow valve positioned between an end of the recirculation line and the tank volume, wherein the recirculation line is in fluid communication with the tank volume when the second flow valve is in an open position. In some embodiments, the first end of the recirculation line is fluidly connected to the boom via at least one of a three way valve and a tee pipe.

In some embodiments, a top portion of the slurry tank includes an opening configured to receive at least a portion of the boom. In some embodiments, the boom may be articulated in such a way that the first end of the boom is insertable into the opening provided in the top portion of the slurry tank. In some embodiments, the slurry tank system includes a pump which is attached to the first end of the boom, the pump being insertable into the opening provided in the top portion of the slurry tank such that the pump is at least partially positioned in the compartment volume of the slurry tank. In some embodiments, the boom includes more than one segment, such as a first boom segment, a second boom segment, and a third boom segment. In some embodiments, the first boom segment is rotatably coupled to the first inlet of the slurry tank, the second boom segment is rotatably coupled to the first boom segment, and the third boom segment is rotatably coupled to the second boom segment. In some embodiments, the first boom segment, the second boom segment, and the third boom segment each provides a fluid flow path that curves about 90 degrees. In some embodiments, the slurry tank system includes a transport structure supporting the slurry tank, the transport structure having a plurality of wheels, such that the slurry tank may be hauled to various locations.

In another aspect, presented herein is a method of dispensing a slurry material, the method including: providing a slurry tank having a tank volume configured to store a slurry material, the slurry tank including a first inlet coupled to an adjustable boom, the slurry tank including a cleanout compartment in a bottom portion of the slurry tank in fluid communication with the tank volume; opening a first flow valve to provide a fluid passageway between the boom and the tank volume; inserting a pump connected to a first end of the adjustable boom into a slurry source containing a slurry material; operating the pump to pump the slurry material from the slurry source into the slurry tank; adjusting the boom to position at least a portion of the pump within the cleanout compartment of the slurry tank through an opening in an upper portion of the slurry tank; and opening a spray valve to provide a fluid passageway between the tank volume and an outlet.

In some embodiments, the method includes: opening a second flow valve to provide a fluid passageway between a recirculation line and the tank volume, the recirculation line in fluid communication with the adjustable boom; and operating the pump to cause slurry material stored within the slurry tank to flow through the recirculation line. In some embodiments, the method includes transporting the slurry tank.

In some embodiments, adjusting the boom to position at least a portion of the pump within the cleanout compartment of the slurry tank through an opening in an upper portion of the slurry tank includes rotating one or more segments of the boom. In some embodiments, rotating one or more segments of the boom is performed via hydraulic actuators. In some of these embodiments, the hydraulic actuators and the pump are powered by a power take off (PTO) of an associated vehicle.

In another aspect, presented herein is a method of making a slurry tank system, the method including: providing a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and connecting a boom to the first inlet of the slurry tank, thereby providing a fluid passageway from a first end of the boom to the tank volume through the first inlet of the slurry tank, wherein at least a portion of the compartment volume is at a lower elevation than the tank volume, and the boom is articulated to allow the first end of the boom to move in at least three degrees of freedom.

In some embodiments, the method includes connecting a pump at the first end of the boom, the boom providing a fluid passageway between the pump and the tank volume. In some embodiments, the method includes positioning a first flow valve between the boom and the slurry tank, the first flow valve providing fluid communication between the boom and the slurry tank when the first flow valve is in an open position. In some embodiments, the method includes connecting a spray nozzle in fluid communication with the tank volume via an outlet of the slurry tank, the spray nozzle configured to discharge a slurry material stored in the slurry tank when a spray valve is in an open position.

In some embodiments, the method includes connecting a recirculation line such that the recirculation line provides a fluid passageway between the boom and the second inlet of the slurry tank. In some embodiments, the method includes positioning a second flow valve between an end of the recirculation line and the tank volume, such that the recirculation line is in fluid communication with the tank volume when the second flow valve is in an open position. In some embodiments, the first end of the recirculation line is fluidly connected to the boom via at least one of a three way valve and a tee pipe. In some embodiments, a top portion of the slurry tank includes an opening configured to receive at least a portion of the boom. In some embodiments, the boom is articulated in such a way that the first end of the boom is insertable into the opening provided in the top portion of the slurry tank. In some embodiments, the method includes connecting a pump to the first end of the boom such that the pump is insertable into the opening provided in the top portion of the slurry tank and is at least partially positionable in the compartment volume of the slurry tank. In some embodiments, the boom comprises a first boom segment, a second boom segment, and a third boom segment.

In some embodiments, the first boom segment is rotatably coupled to the first inlet of the slurry tank, the second boom segment is rotatably coupled to the first boom segment, and the third boom segment is rotatably coupled to the second boom segment. In some embodiments, the first boom segment, the second boom segment, and the third boom segment each provides a fluid flow path that curves about 90 degrees. In some embodiments, the method includes connecting the slurry tank to a transport structure having a plurality of wheels.

### BRIEF DESCRIPTION OF THE DRAWINGS

FIG. 1 is a side view of a slurry tank system according to an embodiment of the present disclosure.

FIG. 2 is a perspective view of a slurry tank system according to an embodiment of the present disclosure.

FIG. 3 is a perspective cut away view of the slurry tank according to an embodiment of the present disclosure.

FIG. 4 is a front cut-away view of a slurry tank showing internal and external features of the slurry tank and system according to an embodiment of the present disclosure.

FIG. 5 is a perspective cut-away view of a slurry tank showing internal and external features of the slurry tank and system according to an embodiment of the present disclosure.

FIG. 6 is a flowchart illustrating a method of making a slurry tank system according to an embodiment of the present disclosure.

FIG. 7 is a flowchart illustrating a method of operating a slurry tank system according to an embodiment of the present disclosure.

### DETAILED DESCRIPTION

As will be explained in more detail below, the slurry tank system and associated methods disclosed herein may be used to store, transport, or distribute a slurry material. The slurry material may be a manure slurry, such as is used as a natural fertilizer, and many of the examples presented herein pertain to this use. However, it should be noted that this is for illustrative purposes only and that the present slurry system and associated methods may be used to load, store, transport, and unload other slurries. For example, the present slurry tank system and associated methods may be used with food processing waste, biosludge, industrial waste, refining wastes, waste from paper production, landfill leachates, concrete or other building materials, fly ash, etc.

### Slurry Tank

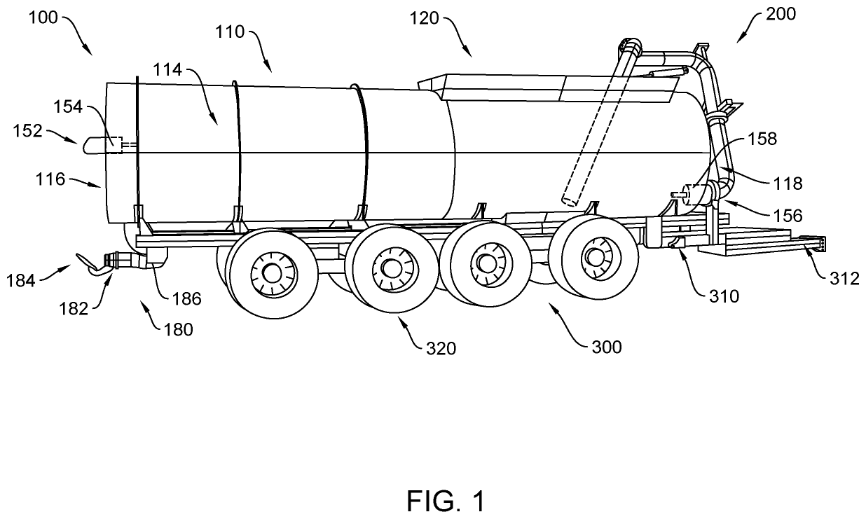

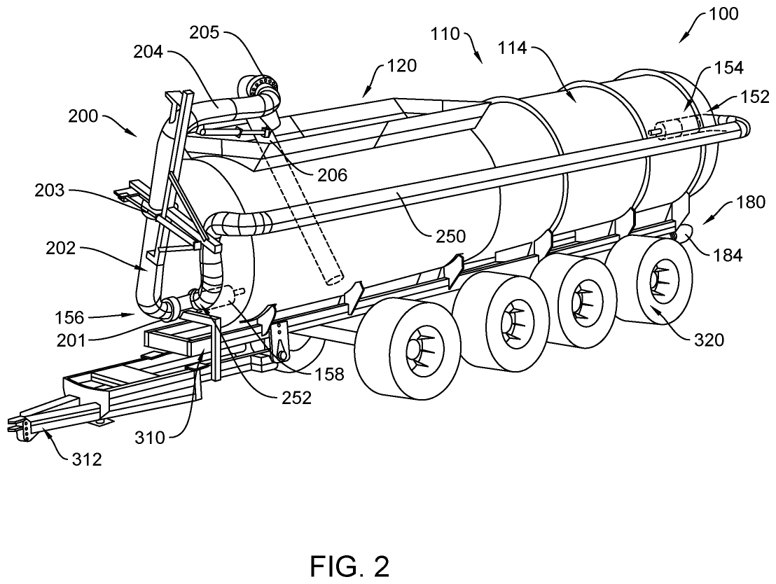

Referring to FIGS. 1 and 2, a slurry tank system 100 is shown. In the illustrated embodiment, the slurry tank system 100 includes a slurry tank 110 having a boom 200 and a recirculation line 250, with the slurry tank system supported by a trailer 300. For the purposes of the present disclosure, the slurry tank system 100 is shown mounted to a trailer 300 in the illustrated embodiment. However, the trailer 300 is optional, and the slurry tank system 100 does not require the trailer. As would be recognized by a person skilled in the art, the slurry tank system 100 could also be fixed in location (i.e., mounted to a block), mounted to a skid or other support structure for transport by lift or another vehicle, or mounted to a truck bed for transport by the truck. In the illustrated embodiment, the trailer 300 includes a chassis 310 for supporting the various components of the slurry tank system 100 and an optional tongue 312 for mounting to a towing vehicle such that the slurry tank system may be pulled behind a vehicle. Alternatively, the slurry tank system may be mounted to a powered chassis, such that it is able to transport itself. The trailer 300 of the illustrated embodiment also includes wheels 320 or skids to allow the trailer to be transported by towing, the wheels or skids and any associated support structures selected to support the weight and other requirements of the slurry tank system.

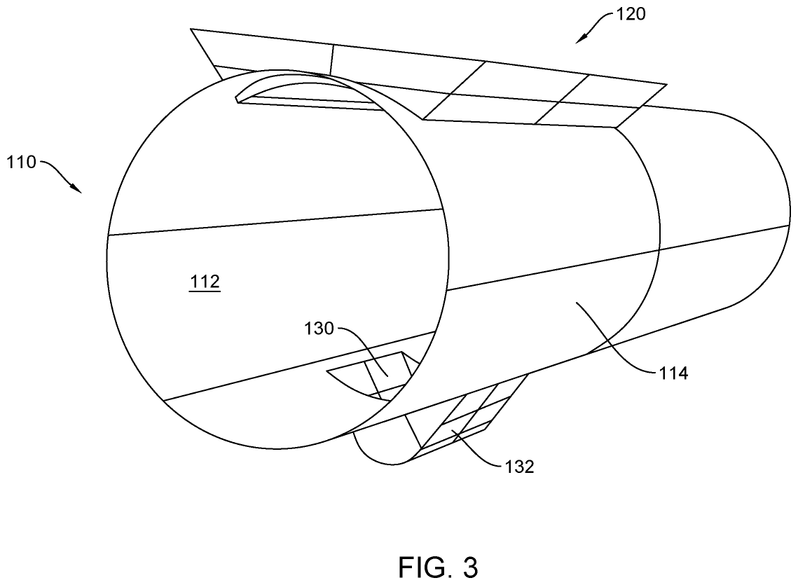

Referring now to FIGS. 1-5, the slurry tank 110 of the slurry tank system 100 includes a slurry containment volume 112 within the slurry tank defined by a slurry tank wall 114. The containment volume receives fluid through 114 a first inlet 156 and a second inlet 152. The first and second inlets 156 152 have associated first and second inlet valves 158 154 that may be independently operated to an open or closed position to control fluid flow through the inlets. As will be described in additional detail below, the first and second inlets 156 152 are used to control the flow of the slurry within the slurry tank system 100.

The slurry tank wall 114 may be made up of several parts or may be formed of a single wall. In some embodiments, such as that illustrated in the figures, the slurry tank 110 has an overall cylindrical shape, though other shapes (such as spheres, hemispheres, rectangular or triangular prisms, etc.) may also be suitable. In some embodiments, the slurry tank 110 also includes a front wall 116 and/or a rear wall 118. In embodiments including a front and/or a rear wall 116 118, the front and/or rear walls are coupled to or engage with the one or more slurry tank walls 114 to define the slurry containment volume 112. In other embodiments, the shape slurry tank 110 is such that a front and/or rear wall 116 118 is not required to define the slurry containment volume 112 (e.g., as non-limiting examples, the slurry tank may be cylindrical, spherical, semi-cylindrical, semi-spherical, elliptical, semi-elliptical, capsule, or stadium-shaped, thus not requiring a front/back wall). In some embodiments having a front wall 116 and/or a rear wall 118, the first inlet 156 and second inlet 152 provide a fluid passage through the front wall and/or rear wall, respectively. In other embodiments, the first inlet 156 and/or the second inlet 152 are positioned on the slurry tank wall 114.

The slurry tank 110 includes an opening 120 and a cleanout compartment 130 defined by a compartment wall 132. The slurry containment volume 112 of the slurry tank 110 is configured to hold a slurry material. The slurry containment volume 112 may include a lining to reduce erosion or corrosion of the slurry tank 110. The slurry containment volume 112 may include sloped walls to assist with directing the flow or liquid level of the slurry material within the slurry containment volume. The cleanout compartment 130 of the slurry tank 110 is positioned at or near the bottom of the tank, so that the cleanout compartment has a lower elevation than most or all of the slurry containment volume 112. Thus, slurry material within the slurry tank 110 will accumulate in the cleanout compartment 130 before filling the remainder of the tank. The slurry tank walls 114 may be shaped to direct slurry material toward the cleanout compartment 130, e.g., the walls may be sloped with the cleanout compartment as the lowest point in the tank. The cleanout compartment 130 may include a door (not shown) that allows access to the cleanout compartment from outside of the slurry tank 110.

The boom 200 is a pipe or other fluid passageway in fluid communication with the slurry containment volume 112 via the first inlet 156. The boom 200 is also in fluid communication with the recirculation line 250 via a tee or other connection 252 that allows fluid to flow from the boom into the recirculation line and from the recirculation line into the boom, depending on the mode of operation. A recirculation valve (not shown) may be positioned at the tee 252 between the boom 200 and the recirculation line 250, allowing fluid flow between them to be throttled or prevented. In some embodiments, recirculation valve is a three way valve, allowing for fluid flow to be selectably directed to the boom 200, the containment volume 112 via the first inlet 156, and the recirculation line 250.

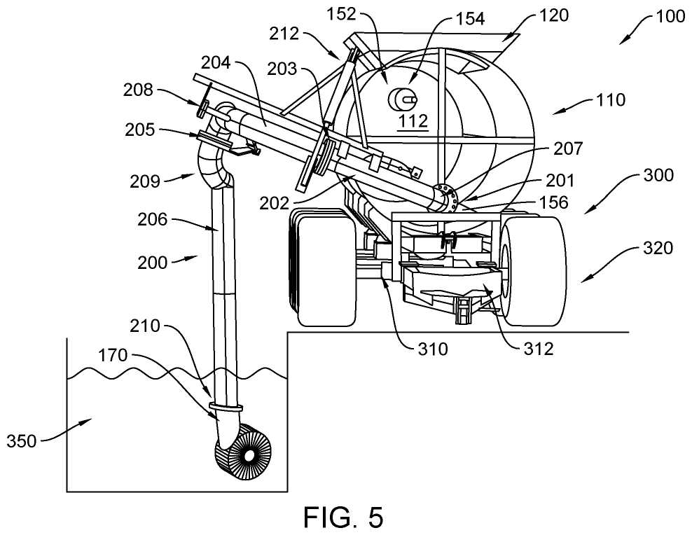

A pump 170 is positioned at a free end of the boom 200, the pump being configured to pump fluid into the boom or to pull fluid out of the boom. The pump may be a positive displacement pump, a centrifugal pump, a piston pump, a rotary pump, a vacuum pump, a diaphragm pump, or any other suitable pump for moving slurry. With specific reference to FIG. 5, during loading operations, slurry is pumped into the containment volume 112 through the first inlet 156 of the slurry tank 110 by the pump 170 located at an end of the boom 200. The pump 170 may be inserted into a reservoir containing the slurry 350. Operation of the pump 170 pushes the slurry material into the boom 200, which then directs the slurry into the slurry tank 110 through the first inlet 156 or through the second inlet 152 via the recirculation line 250. During the loading operation, the first inlet valve 158 and the second inlet valve 154 can be opened or closed as needed to direct the slurry to flow into the tank through the desired opening.

Returning to reference FIGS. 1-5, in the shown embodiment, the slurry tank 110 has an opening 120 positioned at an upper portion of or near the top of the slurry tank 110, though it is also contemplated that the opening may be positioned on the sides or an end of the slurry tank. A cover (not shown) may be provided to cover the opening 120 of the slurry tank 110 between loading operations, thereby preventing contaminants or other unwanted material from entering the slurry tank. The opening 120 of the slurry tank 110 also permits access to the internal volume of the slurry tank for maintenance operations, and so may be sized such that tools and/or personnel may enter the slurry tank during maintenance operations.

The boom 200 is articulated such that the free end 210 of the boom may be positioned inside of the slurry tank 110. For example, in some embodiments, the boom 200 is articulated such that the pump 170 at the free end 210 of the boom is able to be positioned at least partially within the slurry tank containment volume 112 and/or the cleanout compartment 130 of the slurry tank 110. In this way, the pump may be used to pump material contained within the containment volume 112 and the cleanout compartment 130. This feature also allows the pump 170 to be used to recirculate material in the slurry tank 110 by pumping material in the containment volume 112 of the tank through the boom 200. The recirculated slurry material may be directed back into the containment volume 112 through the recirculation line 250 and the second inlet valve 154, from the boom through the first inlet valve 158, or through both valves. Recirculating the slurry in this manner can prevent or prolong settling of solid particulate out of the slurry. In this way, a single pump 170 located at the end of the boom can be used to both load slurry material into the tank and to cause the slurry to be recirculated.

In the illustrated embodiment of FIGS. 1-5, the boom has three points of articulation. The first point of articulation is the first swivel connection 201 between the boom 200 and the slurry tank 110, allowing the first boom segment 202 of the boom to rotate around an axis substantially aligned with the first inlet 156 and the slurry tank. The second point of articulation is a second swivel connection 203 between the first boom segment 202 and the second boom segment 204. A third swivel connection 205 connects the second boom segment 204 and the third boom segment 206. Although three points of articulation are shown in the illustrated embodiments, it should be understood that more or fewer points of articulation may be used. For example, the boom may include two, four, five, or six or more points of articulation. And while the articulation points shown in the illustrated embodiment are swivel joints, other articulation points are also contemplated. For example, universal joints, ball and socket joints, flexible hose sections, telescopic piping sections, gimbal joints, or combinations of two or more thereof may be used as alternatives or in addition to the shown swivel joints.

The boom segments 202 204 206 may be straight. However, in the illustrated embodiment, the boom segments, 202 204 2026 are curved and so provide a fluid flow path that is curved. For example, in the illustrated embodiment, the first boom segment 202 has a first curved portion 207 that curves approximately 90 degrees. The second boom section 204 and third boom section 206 are also both illustrated having curved portions 208 209 that each curve approximately 90 degrees. Other curves or connections may also be used to achieve the effect of having the pump 170 on the free end 210 of the boom 200 be positionable into the cleanout compartment 130 of the slurry tank 110. In some embodiments, flexible connections are used rather than swivel connections, allowing the boom segments 202 204 206 to be movable into the required positions to insert the pump 170 into the cleanout compartment 130. In some embodiments, only one boom segment is curved. In other embodiments, two boom segments are curved. In some embodiments, one or more boom segments has more than one curved portion. The curved sections may include a curve ranging from 15-180 degrees.

The boom 200 may include one or more boom actuators 212 to position the boom segments 202 204 206. A boom actuator 212 may be operated to cause one or more of the boom segments 202 204 206 to change position, i.e., to rotate on the swivel connection, or to raise or lower, extend or retract, or otherwise move, depending on the configuration and the type of joint used. The boom actuators 212 may be connected to a controller to automate the movement of the boom segments 202 204 206.

The slurry tank system includes a spray nozzle assembly including a spray nozzle 182 in fluid communication with the containment volume 112 of the slurry tank 110 through an outlet of the tank. The spray nozzle 182 is configured to discharge slurry material out of the tank 110. For example, the slurry nozzle may be used to spread a manure slurry on a field as fertilizer. The spray nozzle assembly 180 may include piping 186 between the outlet of the slurry tank 110 and the spray nozzle 182 and may also include a dispersal plate 184 positioned such that the slurry leaving the spray nozzle impacts the plate, thereby increasing the spread of the slurry as it is sprayed from the nozzle. In some embodiments, the outlet piping is in fluid communication with the boom or the recirculation line such that the pump may feed slurry material to the outlet piping 186, thereby allowing the slurry material stored in the slurry tank to be pumped out of the spray nozzle.

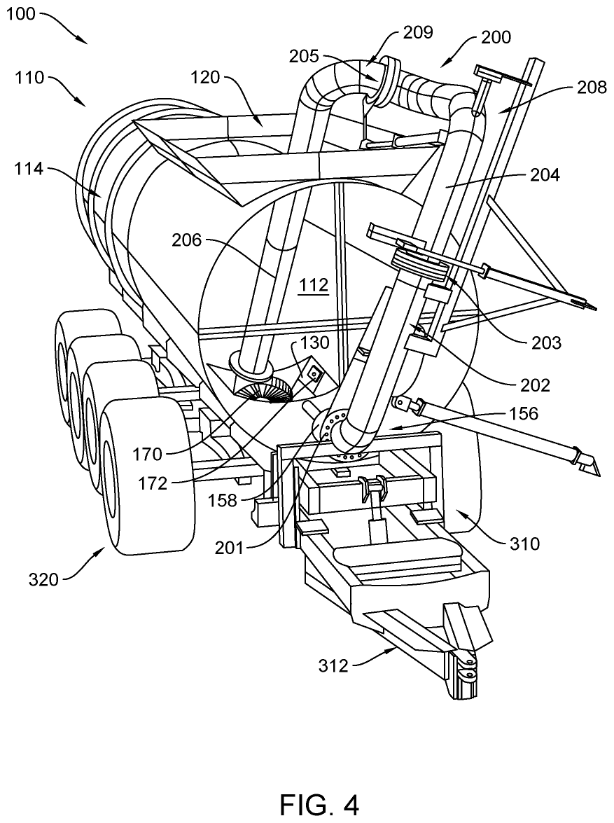

As illustrated in FIG. 4, the slurry tank system may include a sensor 172 positioned within the cleanout compartment of the tank that detects that fluid level within the slurry tank. In some embodiments, the sensor detects when the fluid level within the slurry tank drops to a predetermined level and sends a signal to a controller, which then shuts off the pump. This sensor can prevent the pump from running without slurry to pump, thereby preventing damage to the pump. In some embodiments, the sensor is positioned on the pump itself, rather than being positioned on the slurry tank. In some embodiments, multiple sensors are used to ensure that the pump shuts off once a predetermined fluid level is reached. Sensor data may also be used to automate other tasks, such as shutting or opening various valves, or to trigger an output to an operator of the slurry tank (e.g., light an indicator, sound an alarm, send a signal to a communication system, etc.).

### Method of Making a Slurry Tank System

A method of making a slurry tank system 600 is provided herein. The method may be used to create a slurry tank system capable of being used with the method of dispensing slurry, also described herein.

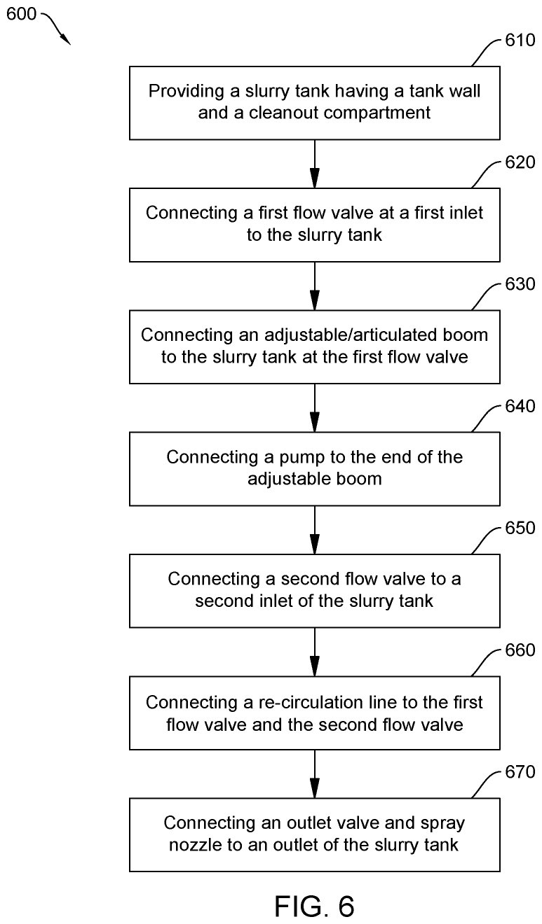

In a first step 610 of the method, as illustrated in FIG. 6, a slurry tank is provided. The slurry tank includes an internal volume defined by a tank wall, the internal volume fluidly accessible through a first inlet, a second inlet, and an outlet. The tank wall includes an opening for receiving a portion of a boom and a pump, as described herein. The opening for the boom may be positioned at or near the top of the tank, and should be large enough to accommodate a pump. The tank optionally includes a cleanout compartment, a portion of the tank having a volume positioned lower in elevation that other portions of the tank, which will continue to hold slurry as the tank empties. A fluid level sensor may optionally be positioned within the tank volume or the cleanout compartment specifically or optionally on the pump, which can provide a signal to indicate the fluid level or to indicate that a predetermined fluid level has been reached. This may be useful, for example, when emptying the slurry tank to automatically shut off the pump when a low slurry level is detected in the tank or as the pump is retracted from the slurry.

In another step 620, a first flow valve is connected in fluid communication with the first inlet of the slurry tank. The valve may be manually actuated, or may be hydraulically or pneumatically actuatable. The valve may be threadedly connected to the slurry tank inlet, or it may be permanently affixed, such as by welding. The first flow valve may be connected directly to the first inlet, or another valve or other piping may be present between the first flow valve and the first inlet. For example, it may be desirable to have a standoff or nipple on the inlet and then connect the valve to the standoff or nipple. It may be desired to include another valve between the first flow valve and the inlet. The additional valve, if desired, can be any type appropriate for controlling the slurry flow, including ball valves, globe valves, and gate valves, as non-limiting examples. The first flow valve may be a three-way valve, capable of directing fluid flow between three connected fluid flow channels. As will be described in more detail below, the first fluid flow valve may be fluidly connected to a boom and a recirculation line, in a additional to the slurry tank. When the first fluid valve is a three-way valve, it should be configured to control fluid flow between these elements of the slurry tank system. It should also be noted that a four-way valve may also be used, if desired. In other embodiments, multiple valves may be used to the same effect, such as placing a single valve between the boom and the slurry tank volume and another between the boom and the recirculation line. By closing and opening the valves as desired, flow of fluid from the boom can be directed to the slurry tank volume, the recirculation line, both, or neither.

In another step 630, an adjustable or articulated boom is connected to the first flow valve, thereby being placed in fluid communication with the internal volume of the slurry tank. The boom may be threadedly connected to the valve, or it may be permanently affixed by welds or other known methods. The boom is adjustable in position and should have sufficient freedom of movement that an end of the boom is insertable into the opening in the slurry tank when the boom is connected to the tank. The boom may be a single piece, but is preferably formed of segments with articulation between the segments as described previously. The boom or boom segments may be manually actuatable or may be moved by use of hydraulic and/or pneumatic actuators. For example, as in the illustrated embodiments (see, e.g., FIG. 5), the boom may comprise three segments having swivel connections between them. Hydraulic actuators may be positioned to rotate the segments at the swivel connections. The segments have curves or may be straight. Other connections may also be used, such as flexible piping or tubing, such that the boom has sufficient flexibility and freedom of movement that the end may be inserted into the opening of the tank.

In another step 640, a pump is connected to the end of the boom. The pump is connected such that the pump is in fluid communication with the boom and can push fluid into or pull fluid from the boom. The pump is preferably capable of operating in either direction, though a one-directional pump may also be used, so long as it is configured to cause fluid to flow into the boom. The pump may be a positive displacement pump, a centrifugal pump, a piston pump, a rotary pump, a vacuum pump, a diaphragm pump, or any other suitable pump for moving slurry. The pump may receive power from an electrical connection from a generator, a combustion engine, or any other suitable power source. When the slurry tank system is mounted to a vehicle, the pump may be powered by a power take off (PTO) associated with the vehicle.

In another step 650, a second fluid flow valve is connected to the slurry tank at the second inlet. As with the first fluid flow valve at the first inlet, the second fluid flow valve may be threadedly connected, or may be permanently affixed to the inlet. The valve may be any type appropriate for controlling the flow of a slurry, including ball valves, globe valves, and gate valves, as non-limiting examples. The valve may be manually actuated, or may be hydraulically or pneumatically actuatable. In another step 670, an outlet valve is connected to the outlet of the slurry tank. The outlet valve may also be any type of suitable valve for working with a slurry, including those listed above, and may be manually or automatically actuatable.

In another step 660, a recirculation line is connected to the first fluid flow valve and the second fluid flow valve, providing a fluid conduit between them separate of the slurry tank volume. The recirculation line may be a pipe or tube that provides fluid communication between the valves. The recirculation line is connected at the first fluid flow valve such that fluid may flow from the boom through the recirculation line during operation of the system. In some embodiments, the recirculation line and/or the boom are in fluid communication with the outlet valve through outlet piping.

The system, once assembled, permits the use of a single pump to introduce slurry to the slurry tank and to recirculate slurry within the tank. The pump may also be used to unload the slurry by causing the slurry within the tank to flow toward the outlet of the slurry tank. This is due to the adjustable boom allowing the pump at the end of the boom to be freely positioned in at least a first position or location outside of the slurry tank, such as within a slurry source, and in a second position or location within the tank volume, with a portion of the boom extending through an opening in the tank wall. In this way, the single pump can be used to load slurry into the tank and to circulate slurry within the tank, such as during transport of the tank or dispensing of the slurry. Other features and steps described above should be considered to be optional.

### Method of Dispensing Slurry

A method of dispensing a slurry material is also provided herein. The method may be employed using a slurry tank system such as that previously described. The method includes providing a slurry tank system including a slurry tank with an adjustable or articulated boom, such that an end of the boom is insertable into a slurry tank through an opening in the tank. In some embodiments, the boom can be positioned such that the pump is positioned within a cleanout compartment of the slurry tank that is in fluid communication with the remainder to the tank. The cleanout compartment is generally positioned near the bottom of the tank, such that slurry in the tank accumulates in the cleanout compartment first before filing the rest of the tank, and therefore will empty last when the tank is being emptied. The method includes opening and closing valves to direct the flow of slurry contained within the slurry tank, either loading the slurry into the tank, recirculating it during transport or storage, or dispensing the slurry and at least partially emptying the tank. This method provides may advantages, including being able to use a single pump to load and unload the slurry tank, saving time in connecting various pumps to the boom (as only one is now required and it can stay connected to the boom), and reducing maintenance costs associated with several slurry pumps.

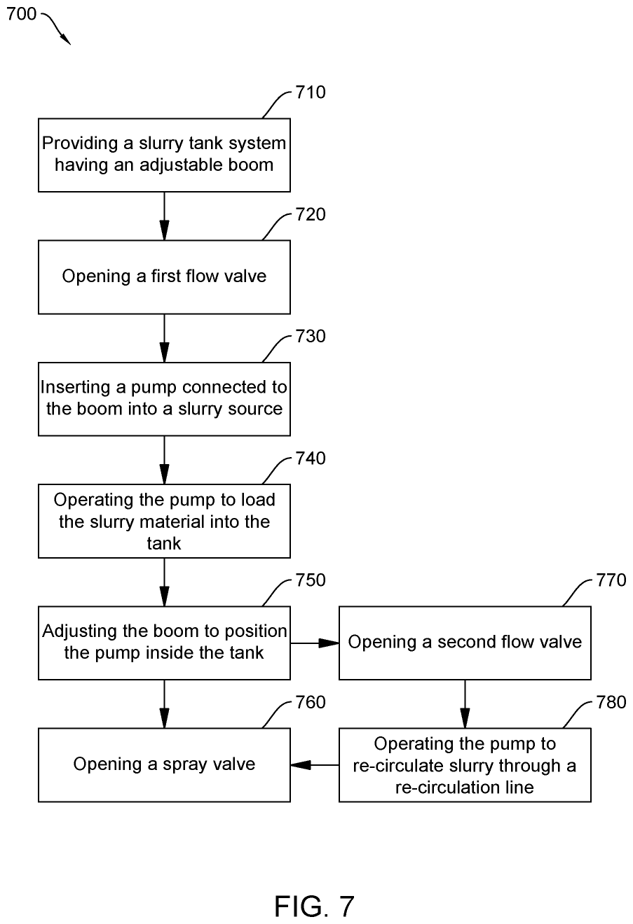

The method of dispensing the slurry 700 is illustrated as a flowchart in FIG. 7. In a first step 710, the slurry having an adjustable boom is provided for dispensing the slurry. The boom includes a pump on an end of the boom, and should be adjustable such a pump on the end of the boom may be selectably positioned within a slurry source or within the slurry tank through an opening in the slurry tank. The slurry tank may be positioned on a vehicle or fixed to a mount or the ground. It may be fixed to a skid for transport by a lift. The pump should be submergible and is powered through means such as a power takeoff from a vehicle, a generator, a fuel cell, or through combustion of fuel. The adjustable boom can provide the pump in the required positioned by adjusting lengths or angles of the boom or segments of the boom, as previously described herein. The boom may include swivel connections at segments of the boom that allow portions of the boom to rotate with respect to each other or the slurry tank. The boom segments may be manually actuatable or may be moved by use of hydraulic and/or pneumatic actuators.

In another step 720, an operator opens a first flow valve connected to an inlet of the slurry tank, so as to provide fluid communication between the boom and the slurry tank volume. The flow valve may be a three way valve, a gate valve, a ball valve, a butterfly valve, or a globe valve, as non-limiting examples, or may include more than one valve in series. The operator may open the valve manually or may provide input to a controller to open the valve.

In another step 730, the operator lowers the pump on the end of the boom into or near a slurry source so that the pump can pump the slurry in the slurry source. The slurry source may be a mixing tank, a collection vat, a settling tank, or another container holding the slurry to be dispensed. The pump may be fully or partially submerged in the slurry, or the pump may be positioned such that an inlet of the pump can contact the slurry. Tubes or pipes may be used to provide a fluid passage between an inlet of the pump and the slurry source. The pump is moved into or near the slurry source by the operator adjusting the position of the boom or segments of the boom, including by moving the segments or rotating them with respect to each other of the slurry tank. The movement of the boom or boom segments may be performed manually by moving the segments and locking them in place (i.e., loosening tightening bolts or other fixtures to allow the segments to move, positioning the segments by hand or by engaging hydraulic/pneumatic controls, and then tightening or locking the fixtures to provide the boom and pump in the desired position). In other embodiments, the movement of the boom is semi-automated or completely automated. The operator may provide an input to a controller that causes the boom to be adjusted by hydraulic/pneumatic actuators to achieve the desired position for the pump.

Once the pump is inserted into or is positioned near the slurry source, in another step 740, the operator operates the pump to move fluid from the slurry source to the slurry tank. The pumping force provided by the pump will cause slurry in the slurry source to move up the boom into the slurry tank through the first valve. The slurry tank may be filled to the desired capacity, measured either by weight or volume.

Once the slurry is loaded into the tank, the operator shuts the pump off and closes the first valve to prevent the slurry from exiting the tank. In another step 750, the operator adjusts the position of the boom or the boom segments to place the pump within the slurry tank through an opening in the top. The opening is preferably located near or at the top of the tank and provides enough area for the pump, connected to the boom, to be inserted into the tank. The operator positions the pump in the tank, whether in the main volume of the tank or lower into a cleanout compartment in a lower portion of the tank. The operator may engage a cover over the opening and around the protruding boom once the pump is positioned with the tank to prevent contamination of the slurry or slurry from spilling out of the tank during transport.

In some embodiments, the operator may take steps 770 780 to cause the slurry within the slurry tank to be recirculated. For example, in one step 770, the operator opens a second valve connected to a second inlet of the slurry tank. The second valve is also connected to a recirculation line that runs to the first valve and provides fluid communication between. The first valve may be a three way valve, providing a selection of fluid communication between the slurry tank, the boom, and the recirculation line. The operator may adjust the first valve to provide fluid communication between the boom and the recirculation line at the first valve position. The operator operates the pump in another step 780, causing the pump to pull slurry contained within the slurry tank into the boom, which then proceeds to flow through the recirculation line through the first valve. From the recirculation line, the slurry returns to the slurry tank through the second valve. Again, as before, any opening, adjustments to, or closing of valves may be performed manually or automatically through actuators. In some embodiments, the operator selects a recirculation mode from a controller connected to the first and second valve and the pump, and the controller adjusts the valves and provides power to the pump to cause the slurry to recirculate within the slurry tank system.

When the operator is prepared to dispense the slurry, in another step 760, the operator opens a spray valve located at an outlet of the slurry tank. The valve may be opened manually or automatically by a controller in response to an input, such as a command from the operator or the slurry tank being at a predetermined position. The pump may continue to recirculate the slurry during the dispensing operation, or it may be shut off. The rate of dispensing of the slurry may be measured, if desired, as a volumetric or mass flow rate. Once the desired volume or mass of slurry has been dispensed, the operator closes the spray valve. The pump may continue to recirculate the slurry during the dispensing operation, or it may be shut off. When running, the valves are positioned such that pump will circulate slurry from the tank through boom and the recirculation line into the tank through the second inlet of the tank. In the illustrated embodiment (see, FIGS. 1-5), the second inlet is located near the front of the tank near the spray outlet. Thus, in such embodiments, running the pump causes additional slurry material to be constantly deposited near the outlet of the tank, thereby increasing the overall amount of slurry that is distributed. If the pump, coupled to the end of the boom, is positioned in a cleanout compartment of the tank, even material that collects in the cleanout compartment may be successfully distributed. In other embodiments, the pump is in fluid communication with the outlet of the tank through an outlet pipe. The outlet pipe may be in fluid communication with either or both the recirculation line and the boom. For example, the outlet pipe may be connected to the recirculation line before the second inlet valve. Thus, when the first and second inlet valves are closed, operation of the pump will pump slurry material in the tank to the outlet through the outlet piping. While the pump continues to run, it is advisable that the operator ensure that the pump inlet remain submerged in the slurry so as to prevent damage to the pump.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled,” “connected,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled,” “connected,” or variations thereof are modified by an additional term (e.g., directly coupled), the generic definition of the terms provided above is modified by the plain language meaning of the additional term (e.g., “directly coupled” means the joining of two members without any separate intervening member), resulting in a narrower definition than the generic definition than provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the various embodiments is illustrative only. Additionally, any element disclosed in one embodiment may be incorporated or utilized with any other embodiment disclosed herein.
Paragraph A. A slurry tank system including a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and a boom in fluid communication with the first inlet of the slurry tank and providing a fluid passageway from a first end of the boom to the tank volume through the first inlet or the second inlet of the slurry tank, wherein at least a portion of the compartment volume is at a lower elevation than the slurry tank volume, and wherein the boom has one or more articulation points such that a first end of the boom can be selectably positioned in a first position and a second position wherein, when in the first position, the first end of the boom is located outside the slurry tank and, when in the second position, the first end of the boom is located inside the slurry tank.
Paragraph B. The slurry tank system of Paragraph A, further including a pump positioned at the first end of the boom, the boom providing a fluid passageway between the pump and the slurry tank.
Paragraph C. The slurry tank system of Paragraph A, further including a first flow valve positioned between the boom and the slurry tank, the first flow valve providing fluid communication between the boom and the slurry tank when the first flow valve is in an open position.
Paragraph D. The slurry tank system of Paragraph A, further including a spray nozzle in fluid communication with the tank volume via an outlet of the slurry tank; the spray nozzle configured to discharge a slurry material stored in the slurry tank when a spray valve is in an open position.
Paragraph E. The slurry tank system of Paragraph A, further including a recirculation line, the recirculation line providing a fluid passageway between the boom and at least one of the first inlet and the second inlet of the slurry tank.
Paragraph F. The slurry tank system of Paragraph E, further including a second flow valve positioned between an end of the recirculation line and the tank volume, wherein the recirculation line is in fluid communication with the tank volume when the second flow valve is in an open position.
Paragraph G. The slurry tank system of Paragraph E, wherein a first end of the recirculation line is fluidly connected to the boom via at least one of a three way valve and a tee pipe.
Paragraph H. The slurry tank system of Paragraph A, wherein the boom comprises a first boom segment, a second boom segment, and a third boom segment, and wherein the first boom segment is rotatably coupled to the slurry tank, the second boom segment is rotatably coupled to the first boom segment, and the third boom segment is rotatably coupled to the second boom segment.
Paragraph I. A method of dispensing a slurry material, the method including: providing a slurry tank having a tank volume configured to store a slurry material, the slurry tank including a first inlet coupled to an articulated boom, the slurry tank including a cleanout compartment in a bottom portion of the slurry tank in fluid communication with the tank volume; opening a first flow valve to provide a fluid passageway between the boom and the tank volume; adjusting the position of the boom such that a pump connected to a first end of the adjustable boom is positioned in a slurry source containing a slurry material; operating the pump to pump the slurry material from the slurry source into the slurry tank; adjusting the boom to position at least a portion of the pump within the cleanout compartment of the slurry tank through an opening in the slurry tank; and opening a spray valve to provide a fluid passageway between the tank volume and an outlet.
Paragraph J. The method of Paragraph I, further including: opening a second flow valve to provide a fluid passageway between a recirculation line and the tank volume, the recirculation line in fluid communication with the adjustable boom; and operating the pump to cause slurry material stored within the slurry tank to flow through the recirculation line.
Paragraph K. The method of Paragraph I, further including transporting the slurry tank.
Paragraph L. The method of Paragraph I, wherein adjusting the boom includes rotating one or more segments of the boom.
Paragraph M. The method of Paragraph L, wherein rotating one or more segments of the boom is performed via hydraulic actuators.
Paragraph N. A method of making a slurry tank system, the method including: providing a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and connecting a boom to the first inlet of the slurry tank, thereby providing a fluid passageway from a first end of the boom to the tank volume through the first inlet of the slurry tank, wherein at least a portion of the compartment volume is at a lower elevation than the tank volume, and, and wherein the boom is articulated to allow the first end of the boom to move in at least three degrees of freedom and the slurry tank includes an opening configured to receive at least a portion of the boom.
Paragraph O. The method of making a slurry tank system of Paragraph N, further including connecting a pump at the first end of the boom, the boom providing a fluid passageway between the pump and the tank volume.
Paragraph P. The method of making a slurry tank system of Paragraph N, further including positioning a first flow valve between the boom and the slurry tank, the first flow valve providing fluid communication between the boom and the slurry tank when the first flow valve is in an open position.
Paragraph Q. The method of making a slurry tank system of Paragraph N, further including connecting a recirculation line such that the recirculation line provides a fluid passageway between the boom and the second inlet of the slurry tank.
Paragraph R. The method of making a slurry tank system of Paragraph Q, further comprising positioning a second flow valve between an end of the recirculation line and the tank volume, such that the recirculation line is in fluid communication with the tank volume when the second flow valve is in an open position.
Paragraph S. The method of making a slurry tank system of Paragraph N, wherein the boom includes a first boom segment, a second boom segment, and a third boom segment.
Paragraph T. The method of making a slurry tank system of Paragraph S, wherein the first boom segment is rotatably coupled to the first inlet of the slurry tank, the second boom segment is rotatably coupled to the first boom segment, and the third boom segment is rotatably coupled to the second boom segment.

What is claimed is:

1. A slurry tank system comprising:
a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and
a boom in fluid communication with the first inlet of the slurry tank and providing a fluid passageway from a first end of the boom to the tank volume through the first inlet or the second inlet of the slurry tank,
wherein at least a portion of the compartment volume is at a lower elevation than the slurry tank volume, and
wherein the boom has one or more articulation points such that a first end of the boom can be selectably positioned in a first position and a second position wherein, when in the first position, the first end of the boom is located outside the slurry tank and, when in the second position, the first end of the boom is located inside the slurry tank.

2. The slurry tank system of claim 1, further comprising a pump positioned at the first end of the boom, the boom providing a fluid passageway between the pump and the slurry tank.

3. The slurry tank system of claim 1, further comprising a first flow valve positioned between the boom and the slurry tank, the first flow valve providing fluid communication between the boom and the slurry tank when the first flow valve is in an open position.

4. The slurry tank system of claim 1, further comprising a spray nozzle in fluid communication with the tank volume via an outlet of the slurry tank; the spray nozzle configured to discharge a slurry material stored in the slurry tank when a spray valve is in an open position.

5. The slurry tank system of claim 1, further comprising a recirculation line, the recirculation line providing a fluid passageway between the boom and at least one of the first inlet and the second inlet of the slurry tank.

6. The slurry tank system of claim 5, further comprising a second flow valve positioned between an end of the recirculation line and the tank volume, wherein the recirculation line is in fluid communication with the tank volume when the second flow valve is in an open position.

7. The slurry tank system of claim 5, wherein a first end of the recirculation line is fluidly connected to the boom via at least one of a three way valve and a tee pipe.

8. The slurry tank system of claim 1, wherein the boom comprises a first boom segment, a second boom segment, and a third boom segment, and
wherein the first boom segment is rotatably coupled to the slurry tank, the second boom segment is rotatably coupled to the first boom segment, and the third boom segment is rotatably coupled to the second boom segment.

9. A method of dispensing a slurry material, the method comprising:
providing a slurry tank having a tank volume configured to store a slurry material, the slurry tank including a first inlet coupled to an articulated boom, the slurry tank including a cleanout compartment in a bottom portion of the slurry tank in fluid communication with the tank volume;
opening a first flow valve to provide a fluid passageway between the boom and the tank volume;
adjusting the position of the boom such that a pump connected to a first end of the adjustable boom is positioned in a slurry source containing a slurry material;
operating the pump to pump the slurry material from the slurry source into the slurry tank;
adjusting the boom to position at least a portion of the pump within the cleanout compartment of the slurry tank through an opening in the slurry tank; and
opening a spray valve to provide a fluid passageway between the tank volume and an outlet.

10. The method of claim 9, further comprising:
opening a second flow valve to provide a fluid passageway between a recirculation line and the tank volume, the recirculation line in fluid communication with the adjustable boom; and
operating the pump to cause slurry material stored within the slurry tank to flow through the recirculation line.

11. The method of claim 9, further comprising transporting the slurry tank.

12. The method of claim 9, wherein adjusting the boom includes rotating one or more segments of the boom.

13. The method of claim 12, wherein rotating one or more segments of the boom is performed via hydraulic actuators.

14. A method of making a slurry tank system, the method comprising:
providing a slurry tank having at least one tank wall defining a tank volume configured to store a slurry material, the slurry tank including a first inlet and a second inlet, the slurry tank including a cleanout compartment in a bottom portion of the slurry tank, the cleanout compartment having at least one compartment wall and defining a compartment volume in fluid communication with the tank volume; and
connecting a boom to the first inlet of the slurry tank, thereby providing a fluid passageway from a first end of the boom to the tank volume through the first inlet of the slurry tank,
wherein at least a portion of the compartment volume is at a lower elevation than the tank volume, and, and
wherein the boom is articulated to allow the first end of the boom to move in at least three degrees of freedom and the slurry tank includes an opening configured to receive at least a portion of the boom.

15. The method of making a slurry tank system of claim 14, further comprising connecting a pump at the first end of the boom, the boom providing a fluid passageway between the pump and the tank volume.

16. The method of making a slurry tank system of claim 14, further comprising positioning a first flow valve between the boom and the slurry tank, the first flow valve providing fluid communication between the boom and the slurry tank when the first flow valve is in an open position.

17. The method of making a slurry tank system of claim 14, further comprising connecting a recirculation line such that the recirculation line provides a fluid passageway between the boom and the second inlet of the slurry tank.

18. The method of making a slurry tank system of claim 17, further comprising positioning a second flow valve between an end of the recirculation line and the tank volume, such that the recirculation line is in fluid communication with the tank volume when the second flow valve is in an open position.

19. The method of making a slurry tank system of claim 14, wherein the boom comprises a first boom segment, a second boom segment, and a third boom segment.

20. The method of making a slurry tank system of claim 19, wherein the first boom segment is rotatably coupled to the first inlet of the slurry tank, the second boom segment is rotatably coupled to the first boom segment, and the third boom segment is rotatably coupled to the second boom segment.
